(19) United States
(12) Patent Application Publication
(10) Pub. No.: US 2007/0089979 A1
(43) Pub. Date: Apr. 26, 2007

(54) A METHOD AND DEVICE FOR THE SURFACE TREATMENT OF A METAL SUBSTRATE, AND CORRESPONDING PRODUCT

(75) Inventors: Francesco Veltri, Alessandria (IT); Paolo Del Forno, Acqui Terme Al (IT); Gianni Mirone, Alessandria (IT)

Correspondence Address: MERCHANT & GOULD PC, P.O. BOX 2903, MINNEAPOLIS, MN, 55402-0903, US

(73) Assignee: METLAC S.p.A., Bosco Marengo AL (IT)

(21) Appl. No.: 10/581,163

(22) PCT Filed: Dec. 2, 2004
(86) PCT No.: PCT/EP04/13720

§ 371 Date: May 31, 2006

(30) Foreign Application Priority Data
Dec. 9, 2003 (IT) TO2003A000985

(51) Int. Cl. H05F 3/00

(52) U.S. Cl. 204/164

(57) ABSTRACT

A method for the surface treatment of a metal substrate, whether previously painted or not, in particular for decorated containers and for decorated containers and for the packaging of foodstuffs consists in applying, using an electrode, an electrical discharge having a voltage of between 17,000 V and 49,000 V and a frequency of between 18 kHz and 24 kHz on the surface of the metal substrate.

The present invention relates to a method and a device for the surface treatment of a metal substrate, designed in particular for decorated containers and for the packaging of foodstuffs, such as for example an electrolytic tin-coated plate, an electrolytic chromium-coated plate, an aluminium, zinc-coated steel laminates, and for the “coil coating” of said metal substrate.

A purpose of the present invention is to propose a method for the surface treatment of a metal substrate that will be particularly suitable for bestowing better performance in terms of adhesion of the painting systems used for the protection of the metal substrate.

A further purpose of the present invention is to propose a method for the treatment of the said painting products used for modifying the surface performance.

As already mentioned, in the sector of decorated containers and of metallic packaging of foodstuffs the steel-based materials used for the fabrication of the containers for foodstuffs are:
electrolytic tin-coated plate; and
electrolytic chromium-coated plate.

Together with these materials, there are used other auxiliary metal materials, which are indispensable for obtaining the final containers.

Electrolytic tin-coated plate (ETP) is the most widespread material in the fabrication of metal steel-based containers for the canning industry and for different uses. In general terms, ETP is made of a thin “soft” steel laminate i.e., with low content of carbon and of other elements; said steel-based material is coated on both of its faces with a thin layer of tin.

The tin of the electrolytic tin-coated plate is deposited on the base steel by means of a continuous electrolytic process; this material is produced in a vast range of qualities, both as regards the amount/quantity of tin deposited per unit surface and as regards its mechanical characteristics.

Electrolytic chromium-coated plate either electrolytic chromium-coated steel (ECCS) or tin-free steel-chromium type (TFS-CT) is a steel-based material, which has been developed with the purpose of reducing the consumption of tin and which, for some applications in the sector of containers, is able to replace electrolytic tin-coated plate.

According to the European Standard EN 10202, the official definition of this product is the following: “sheet or roll of low-carbon steel coated on both faces by means of electrodeposition of a coating consisting of chromium in the metallic state (adherent to a steel base) coated with a layer of chromium oxides or chromium hydroxides”.

Auxiliary steel-based materials are zinc-coated laminates, such as flat steel laminates, either zinc-coated electrolytically or else by immersion in molten zinc.

Already for quite some time now, in particular in the history of the conservation of foods in metal packaging, it is common practice to resort to painting of the surfaces of the containers with the dual function of limiting the phenomena of interaction between metallic species and foods (internal protection) and presentation of the pre-packaged packaging (external protection).

The same applies for metal containers decorated on the outside.

Consequently, polymeric coatings are used in many cases on both of the surfaces of the metal substrate, so that by now it is the latter that provides the structural consistency of the box, whilst the component of the container actually in contact with the product is the so-called “paint”.

For some types of metal laminates and/or alongside the progressive reduction of their thicknesses with the introduction of more extensive and deeper mechanical operations, the paint has assumed a fundamental role in determining their workability.

Painting products designed for the specific use are constituted by a solution or dispersion of one or more resins or polymers in a solvent, which may be an organic mixture or a mixture of water and organic solvents. There are moreover present other components, such as catalysts, plasticizers, ???extenders, lubricants and possible pigments and organic additives.

Listed below are the types of coatings currently used:
undercoats and ???anchoring agents;
white enamels;
epoxyphenolic paints;
colourless overprinting paints;
organosol paints; and
printer's inks

The technologies used may be distinguished into:
solvent-based products; and
water-based products and products in powder form;
ultra-violet cross-linkable products (UV curing) and electron-beam curing (EB curing)

Some of the main parameters that characterize application of the painting product on the metal substrate are represented by:
Wettability of the substrate: this is one of the primary characteristics that emerge in the application of a coating. Problems of wettability of the substrate may be noted, which are represented by “cissing”, i.e., by areas that may even be limited but are distributed more or less throughout the sheet, on which the paint does not wet the base and may derive, for example, from an excessive and/or non-uniform oiling of the tin-coated plate.
Adherence to the substrate: this is one of the main characteristics of a paint product applied and dried.

The main factors that affect the adherence of a paint/ink to the substrate are:
chemical characteristics of structure of the resins constituting the film;
surface characteristics of the substrate, which can be put down to the state of passivation/oxidation in the case of metal laminates;
type and level of lubrication of the substrate; and
correct ???quantity in grams per unit surface and baking/cross-linking of the film applied.

The adherence to the substrate may also have a decisive effect on other properties of the coatings, such as mechanical resistance (the coatings have to withstand mechanical operations without undergoing excessive damage; for example operations of drawing, beading, flanging, seaming, and handling in general); chemical resistance and resistance to thermal treatment (contact with solutions having a wide range of pH values, saline solutions, organic acids, etc., pastorizations, sterilizations).

The UV-cross-linkable coatings (inks and paints) are critical systems that present considerable difficulties of direct adhesion to the metal substrate.

U.S. Pat. No. 3,451,871 describes the treatment of at least one metal part (for example a sheet) for increasing the adherence of a coating layer applied thereon. The treatment is performed by means of an alternating electrical field with high voltage (between 50,000 V and 600,000 V) and high frequency (between 25 kHz and 400 kHz). Preferably, the voltages are between 400,000 V and 600,000 V and the frequencies between 25 kHz and 75 kHz.

It is, hence, a method that presupposes the use of a device (i.e., the electrode) which is very complex to make given the voltages and frequencies at which it is necessary to work and which certainly presents major difficulties of implementation and reliability when used in continuous and fast cycles precisely on account of the high operating values of the voltage and frequency.

In order to achieve the purposes mentioned above and to overcome the drawbacks of the known art cited previously, the present invention proposes carrying out a surface treatment of the metal substrate, constituted by a high-voltage and medium-frequency electrical discharge to be applied on the surface of the material to be treated.

The treatment forming the subject of the invention presents some analogies with the so-called “corona treatment”, which can give some idea as regards what “energy” is exploited in order to obtain the desired effect both on the plastic and on the metal.

Corona treatment is, however, considered such if it is applied on plastic films or small thicknesses, whereas in other more demanding applications, for example large thicknesses of plastic, it is defined as “three-dimensional corona treatment”.

The traditional corona treatment for plastic films is performed using an electrode and a counter-electrode. The electrode normally consists of a metal plate made of more or less thick stainless steel or aluminium. The counter-electrode consists of a rotating cylinder made of aluminium coated with a silicone sheath.

The electrical discharge, which can arrive at 10,000-13,000 V and 10-15 kHz strikes between the electrode and the cylinder. The plastic film that is treated on the side of the electrode slides on the cylinder and is consequently traversed by the discharge, which modifies the polymeric chains, breaking them, and “rendering polar” a material such as PP or PE and thus predisposing it to good adhesion with inks, adhesive, etc.

Three-dimensional corona treatment for objects functions on the same principle as the “traditional” one described above, with the difference that the electrical voltages and frequencies are higher, in the region of 12,000-15,000 V and 15-18 kHz, respectively.

For metals the treatment forming the subject of the invention cannot be defined as “corona treatment” since the material is not “traversed” by the discharge and is not “polarized” but does undergo dry-degreasing.

The treatment for metals according to the invention, may instead be defined as dry-degreasing.

The treatment according to the invention is, in fact, performed by means of a high-voltage and medium-frequency discharge, which is directed onto the sheet of electrolytic tin-coated plate by means of ceramic electrodes. This energy penetrates into the deep layer of the material and brings about detachment therefrom of the fatty particles or contaminants.

On the metal plates there is exploited the energy produced by generators and transformers in order to apply a completely different principle from the above-mentioned “corona treatment”.

The voltage generated is in general approximately 30,000 V (not less than 17,000 V and not more than 49,000 V), with a frequency of approximately 22 kHz (not less than 18 kHz and not more than 24 kHz) applied to the electrode, which is formed by a conducting rod made of stainless steel or aluminium coated with a layer of insulating ceramic. The spark strikes directly between the electrode and the plate to be treated. The plate is not traversed by the discharge and the sparking that is started with the electrode brings about a work of “digging” on the contaminants present on the surface and in depth.

The technical configuration described is the best possible one. There are possible other less effective variants, which envisage the replacement of the ceramic with other insulating materials, such as silicone, resins, or thermosetting materials. The electrode could be made in the form of a rotating roll or a cooled fixed electrode.

The metal substrate, once treated applying the method described previously, presents a surface tension greater than 50 dynes/cm, guaranteeing excellent performance in terms of adherence of the polymeric coatings (paints and inks).

There exist certain paints that are currently used, which adhere already sufficiently well to the metal substrates on which they are spread; consequently, for these paints it is not indispensable to use the treatment of the metal substrate according to the invention, even though this is advantageous for further improving adhesion.

Certain paints, then, must undergo a further surface-coating; for example by means of lithography or ink-jet printing, and these coatings suffer from the same drawbacks as traditional paints spread on metal substrates, i.e., poor force of adhesion.

The treatment according to the invention is advantageous also in this second case, in which the voltage of approximately 30,000 V with a frequency of approximately 22 kHz is applied on the paint already spread and adhering to the metal substrate so as to improve clearly the characteristics of adhesion of other films or paints on the paint that is in direct contact with the metal.

The ensuing examples are provided merely by way of illustration of the present invention (as emerges from laboratory tests) and are not to be understood as being in any way limiting of the sphere of protection, as defined in the annexed claims.

### EXAMPLE 1

In this first example, the treatment was carried out according to the invention directly on the metal substrate, which was subsequently painted.
substrate: electrolytic tin-coated plate type El; passivation 311;
coatings tested for adhesion:
   A) UV off-set ink, applied using a 0.4-cc Duncan Lynch and cross-linked with a UV lamp (of a mercury type) with a total dose of 100 mj/cm²
   B) UV transparent paint, applied using a bar-coater, with a thickness of 6 microns, and cross-linked using a UV lamp (of a mercury type) with a total dose of 300 mj/cm²

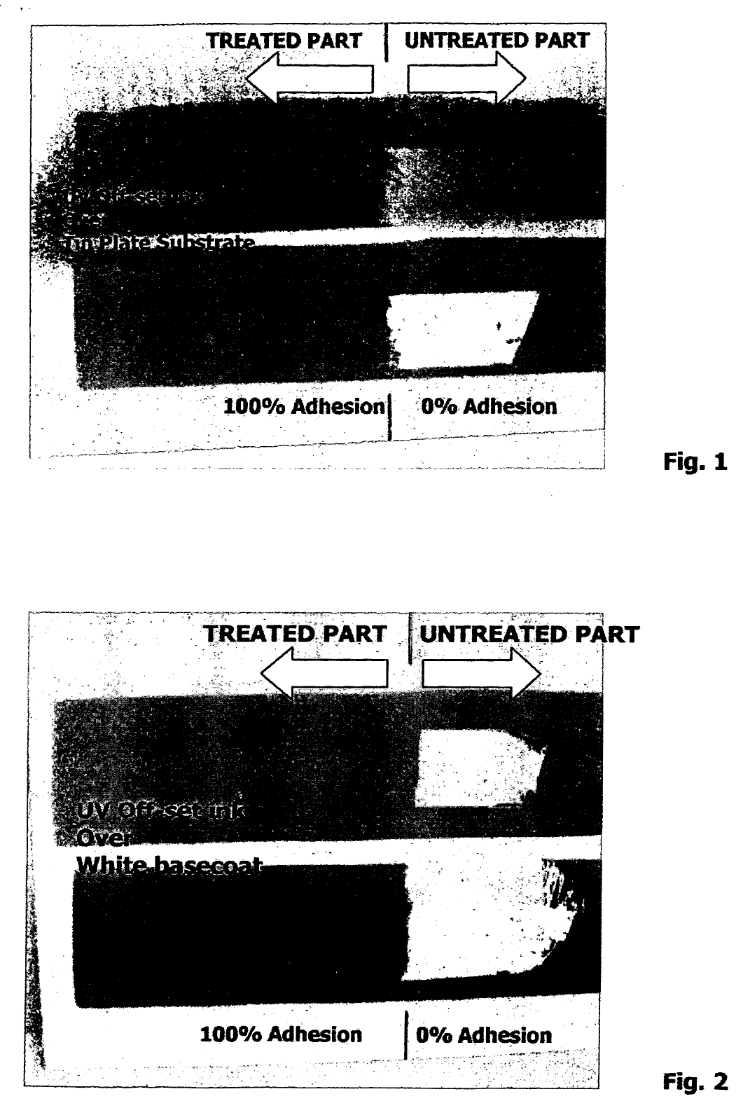

The results of the experiment are clearly visible in the attached FIG. 1.

| Surface tension | | Surface tension of | |
|---|---|---|---|
| of the metal | | the metal | |
| substrate | ADHESION* | substrate | ADHESION* |
| BEFORE | BEFORE | AFTER treatment | AFTER treatment |
| treatment | treatment | “dry degreasing” | “dry degreasing” |
| <32 dynes/cm | A) UV ink: 0% | >50 dynes/cm | A) UV ink: 100% |
| | B) UV | | B) UV paint: 100% |
| | paint: 0% | | |

*ADHESION - tested with the chequered-incision method, with corresponding tearing using a 3M adhesive tape of the 610 type; the results are expressed as percentage of adhered product.

### EXAMPLE 2

Also in this second example, the treatment was performed according to the invention directly on the metal substrate, which was then painted.
substrate: electrolytic chromium-coated plate
coatings tested for adhesion:
   A) UV off-set ink, applied using a 0.4-cc Duncan Lynch and cross-linked using a UV lamp (of a mercury type) with a total dose of 100 mj/cm²

B) UV transparent paint, applied using a bar-coater, with a thickness of 6 microns and cross-linked using a UV lamp (of a mercury type) with a total dose of 300 mj/cm²

| Surface tension | | | |
|---|---|---|---|
| of the metal | | Surface tension of | ADHESION* |
| substrate | ADHESION* | the metal substrate | AFTER |
| BEFORE | BEFORE | AFTER treatment | treatment “dry |
| treatment | treatment | “dry degreasing” | degreasing” |
| <32 dynes/cm | A) UV ink: 0% | >50 dynes/cm | A) UV ink: 100% |
| | B) UV | | A) UV |
| | paint: 0% | | paint: 100% |

*ADHESION - tested with the chequered-incision method, with corresponding tearing using a 3M adhesive tape of the 610 type; the results are expressed as percentage of adhered product.

### EXAMPLE 3

In this third example, instead, the treatment was carried out according to the invention after painting the metal substrate in order to improve its repaintablity with UV cross-linkable coatings.

Treatment of a transparent basecoat of a polyester-melaminic nature and white basecoat of an acrylic-melaminic nature, applied on a metal substrate in order to improve its repaintablity with UV cross-linkable coatings.
substrate: a transparent basecoat of a polyester-melaminic type and a white basecoat of an acrylic-melaminic type, applied on electrolytic tin-coated plate
coatings tested for adhesion:

A) UV off-set ink, applied using a 0.4-cc Duncan Lynch and cross-linked with a UV lamp (of a mercury type) with a total dose of 100 mj/cm²

| | | Surface tension | |
|---|---|---|---|
| | | of the | |
| Type of | ADHESION* | substrate/basecoat | ADHESION* |
| substrate/ | BEFORE | AFTER treatment | AFTER treatment |
| basecoat | treatment | “dry degreasing” | “dry degreasing” |
| Transparent | A) UV ink: 0% | >50 dynes/cm | A) UV ink: 100% |
| basecoat | | | |
| White basecoat | A) UV ink: 0% | >50 dynes/cm | A) UV ink: 100% |

*ADHESION - tested with the chequered-incision method, with corresponding tearing using a 3M adhesive tape of the 610 type; the results are expressed as percentage of adhered product. The results of the experiment are clearly visible in the attached FIG. 2.

### EXAMPLE 4

In this fourth example there is highlighted the effectiveness of the treatment by performing a number of evaluations of measurement of surface tension on metal panels before and after Dry Degreasing treatment through the measurement of the angle contact for evaluating the modification in terms of wettability of the surfaces.
Instrument used for the tests: DATAPHYSIC—Contact Angle System OCA
Reference liquid: distilled H₂O, volume of droplet: 7 microlitres

The instrument carried out a number of scans over an interval of 20 s. At the end, it processed a mean value of the angle of contact of the droplet. A high value of the angle means a low surface tension of the metal, and hence a poor wettability (instead, a low value of the angle means a higher surface tension of the substrate, and hence a better wettability).

A number of readings were carried out on the same surface. The results were obtained as the average of a number of values.

Results

Substrate: Untreated-Tin Plate passivation 311
NOT TREATED
angle of contact: 70.6°-72.0° (mean 71.3°)
Substrate: Untreated-Tin Plate pass. 311
TREATED with Dry Degreasing
angle of contact: 26.6°-27.5° (mean 27.1°)
Substrate: Tin-Free Steel
NOT TREATED
angle of contact: 86.0°-87.4° (mean 86.7°)
Substrate: Tin-Free Steel
TREATED with Dry Degreasing
angle of contact: 55.5°-61.0° (mean 58.2°)

1. A method for the surface treatment of a metal substrate, in comprising applying, using an electrode, an electrical discharge having a voltage of between 17,000 V and 49,000 V and a frequency of between 22 kHz and 24 kHz on the surface of the metal substrate, whether previously painted or not, to be treated.

2. The method according to claim 1, wherein the voltage generated is approximately 30,000 V.

3. The method according to claim 1, wherein the frequency used is approximately 22 kHz.

4. The method according to claim 1, wherein the metal substrate is previously painted.

5. The method according to claim 4, wherein the paint that coats the metal substrate is further coated by means of lithography, ink painting.

6. The method according to claim 1, wherein the metal substrate is not previously painted.

7. A device for the surface treatment of a metal substrate according to the method as per claim 1 wherein the electrode is comprises a conductive rod made of stainless steel or aluminum coated with a layer of insulating ceramic material.

8. A metal substrate, for the packaging of foodstuffs, whether previously painted or not treated, according to the method claim 1 wherein the electrode comprises a conductive rod made of stainless steel or aluminum coated with a layer of insulating ceramic material.
